(19) United States
(12) Patent Application Publication
(10) Pub. No.: US 2016/0193867 A1
(43) Pub. Date: Jul. 7, 2016

(54) Paintbrush Cover

(71) Applicant: Dion Souffle, St. Louis, MO (US)

(72) Inventor: Dion Souffle, St. Louis, MO (US)

(21) Appl. No.: 14/990,492

(22) Filed: Jan. 7, 2016

Related U.S. Application Data
(60) Provisional application No. 62/100,683, filed on Jan. 7, 2015.

(51) Int. Cl. B44D 3/12

(52) U.S. Cl. CPC B44D 3/125

(57) ABSTRACT

A paintbrush cover for protecting and preserving the bristles of a paintbrush between uses. The paintbrush cover comprises a single sheet of material having a center panel on which the bristles of a paintbrush can be positioned. A pair of side flaps extend outwardly from opposing sides of the center panel and are adapted to be wrapped around the bristles of the paintbrush to cover the same. An upper flap extends from the upper portion of the center panel and includes an opening thereon through which the handle of the paintbrush can be positioned. A lower flap extends from the lower end of the center panel and includes a fastener that can removably engage with a fastener on the upper flap so as to secure the cover in a closed position over the paintbrush bristles.

### CROSS REFERENCE TO RELATED APPLICATION

This application claims the benefit of U.S. Provisional Application No. 62/100,683 filed on Jan. 7, 2015. The above identified patent application is herein incorporated by reference in its entirety to provide continuity of disclosure.

### BACKGROUND OF THE INVENTION

### Field of the Invention

The present invention relates to protective covers. More specifically, the present invention provides a protective cover for a paintbrush adapted to protect and preserve the bristles of the paintbrush between uses.

It is important to take care of paintbrushes in order to extend their useful life and to ensure that the paintbrush functions properly when painting a surface. If not properly stored, the bristles of the paintbrush can become bent or otherwise damaged. As a result, the paintbrush may not produce clean, smooth brushstrokes and may instead create streaks on a surface, with a non-uniform distribution of paint. Paintbrushes are often sold in a cardboard packaging, which some users may utilize to protect the paintbrush between uses. However, such cardboard covers are not intended for protecting the paintbrush bristles and may wear out over time. If the bristles of the paintbrush are damaged by failing to properly store and protect the paintbrush, the user may have to replace the paintbrush which can be expensive and inconvenient.

Devices have been disclosed in the prior art that relate to paintbrush covers. These include devices that have been patented and published in patent application publications. These devices generally relate to paintbrush covers having one or more flaps, such as U.S. Pat. No. 5,465,453, U.S. Pat. No. 6,575,295, U.S. Pat. No. 7,007,797, U.S. Pat. No. 5,191,973, and U.S. Pat. No. 2,216,543.

These prior art devices have several known drawbacks. The devices in the prior art fail to provide a paintbrush cover having flaps with a fastener thereon for removably securing the paintbrush cover over the bristles.

In light of the devices disclosed in the prior art, it is submitted that the present invention substantially diverges in design elements from the prior art and consequently it is clear that there is a need in the art for an improvement to existing paintbrush covers. In this regard the instant invention substantially fulfills these needs.

### SUMMARY OF THE INVENTION

In view of the foregoing disadvantages inherent in the known types of paintbrush covers now present in the prior art, the present invention provides a new paintbrush cover wherein the same can be utilized for providing convenience for the user when protecting and preserving the bristles of a paintbrush when the paintbrush is not in use.

It is therefore an object of the present invention to provide a new and improved paintbrush cover comprising a sheet of material having a center panel, a pair of side flaps, an upper flap and a lower flap removably securable to the upper flap, wherein the upper flap further comprises a handle opening through which the handle of the paintbrush can extend.

It is another object of the present invention to provide paintbrush cover composed of a durable and flexible material.

Another object of the present invention is to provide a paintbrush cover comprising a fastener for removably securing the paintbrush cover in position over the bristles of a paintbrush.

Yet another object of the present invention is to provide a paintbrush cover adapted to fully enclose the bristles of a paintbrush in order to protect the same from damage.

Another object of the present invention is to provide a paintbrush cover that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top-down view of the paintbrush cover.

FIG. 2 shows a perspective view of the paintbrush cover positioned for installation on a paintbrush.

FIG. 3 shows a perspective view of a paintbrush cover as used to cover the bristles of a paintbrush.

### DETAILED DESCRIPTION OF THE INVENTION

Reference is made herein to the attached drawings. Like reference numerals are used throughout the drawings to depict like or similar elements of the paintbrush cover. For the purposes of presenting a brief and clear description of the present invention, the preferred embodiment will be discussed as used for covering and protecting the bristles of a paintbrush. The figures are intended for representative purposes only and should not be considered to be limiting in any respect.

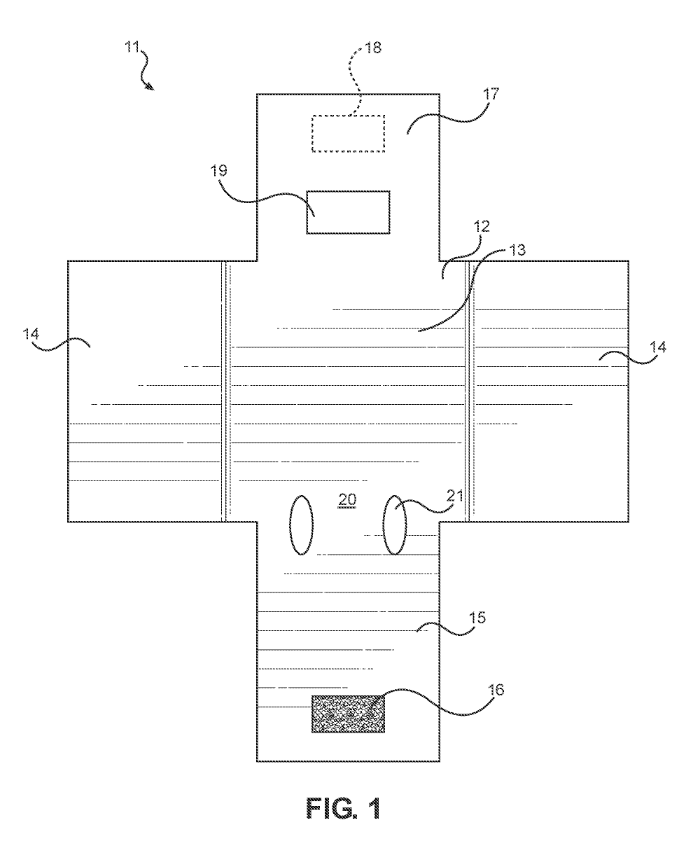

Referring now to FIG. 1, there is shown a top-down view of the paintbrush cover. The paintbrush cover 11 comprises a sheet 12 of material having a center panel 13 having an upper surface 20 on which the bristles of a paintbrush can be positioned. The sheet 12 is composed of a flexible and durable material that protects the bristles of the paintbrush from damage. The paintbrush cover 11 provides a barrier to prevent the paintbrush bristles from being bent while enclosed therein. However, the sheet 12 is flexible enough so that it can be folded so as to cover the paintbrush bristles. In a preferred embodiment, the sheet 12 is composed of high density polyethylene. Further, the material is waterproof so that the paintbrush cover 11 will not be damaged or compromised from repeated contact with water or with a wet paintbrush. The center panel 13 is preferably sized and shaped similarly to the bristle portion of a paintbrush. In the illustrated embodiment, the center panel 13 is rectangular in shape, however, in other embodiments, the center panel 13 is provided in various shapes depending upon the shape of the paintbrush bristles. Generally, the center panel 13 comprises a rectangular or trapezoidal shape.

The center panel 13 comprises a pair of side flaps 14 extending from opposing sides thereof. In the illustrated embodiment, the side flaps 14 are substantially rectangular in configuration. Further, the side flaps 14 are shown as having identical dimensions. The side flaps 14 are adapted to be folded over the center panel 13 so as to enclose the bristles of a paintbrush positioned on the center panel 13. Further, the side flaps 14 are adapted to overlap one another so as to fully enclose the bristles of the paintbrush.

An upper flap 17 extends from an upper portion of the center panel 13. The upper flap 17 comprises a handle opening 19 through which the handle of a paintbrush can extend when the paintbrush cover 11 is applied to the bristles of the paintbrush. Further, the upper flap 17 comprises a fastener 18 on a rear surface thereof, wherein the fastener 18 is adapted to removably engage with a fastener 16 on a lower flap 15 of the paintbrush cover 11. The fasteners 16, 18 preferably comprise a hook and loop fastening material, however, in alternate embodiments the fasteners 16, 18 can be any of various types of fasteners, including buttons, snaps, or magnetic fasteners, among others.

The lower flap 15 extends from the lower portion of the center panel 13, opposite the upper flap 17. The lower flap 15 comprises one or more openings 21 that serve as vents to allow liquid from a wet paintbrush to escape the paintbrush cover 11 when a wet paintbrush is placed therein. The lower flap 15 further comprises a fastener 16 on the front surface 20 thereof that is adapted to removably engage with the fastener 18 on the upper flap 17 as discussed above. The upper flap 17 and lower flap 15 are adapted to be folded over the center panel 13 so as to cover the bristles of a paintbrush positioned thereon. The upper flap 17 and lower flap 15 are removably secured together so as to secure the paintbrush cover 11 over the bristles of a paintbrush and secure the side flaps 14 in a folded position.

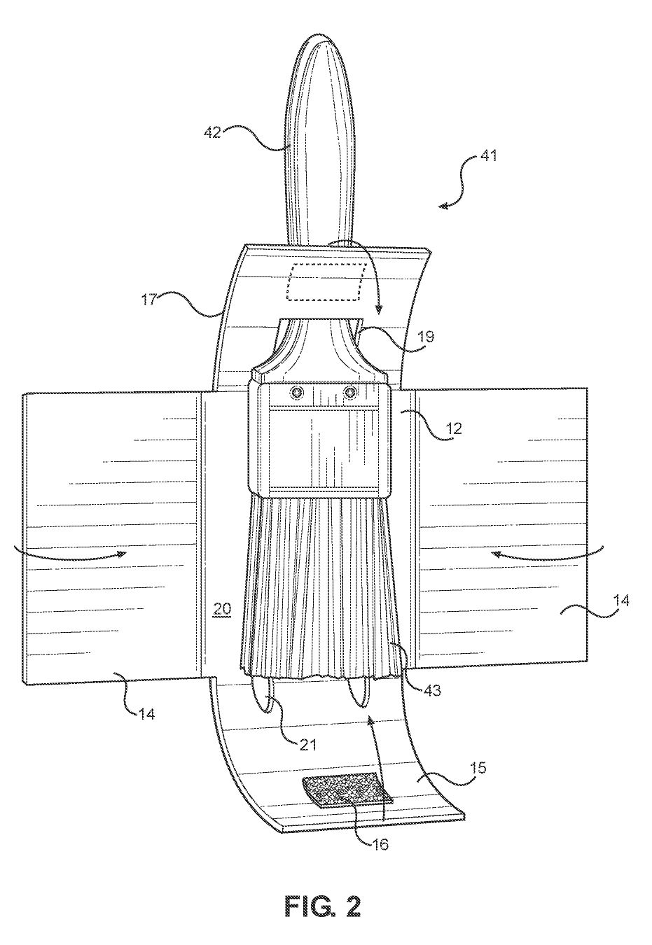

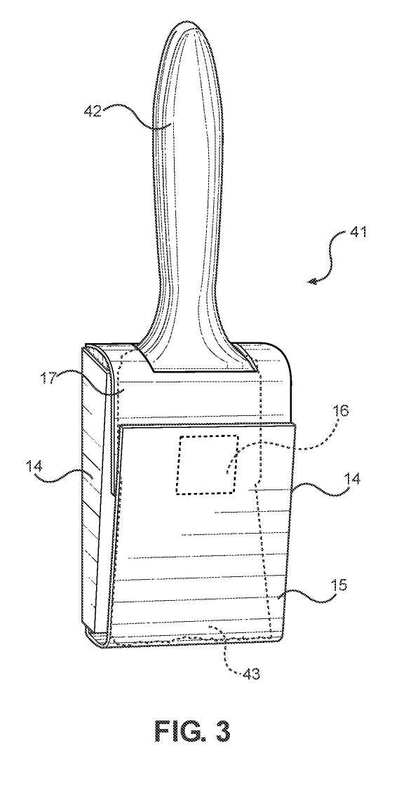

Referring now to FIGS. 2 and 3, there are shown views of the paintbrush cover as positioned for installation and as applied to a paintbrush. In operation, the user can insert the handle 42 of a paintbrush 41 through the handle opening 19 of the upper flap 17 of the paintbrush cover 11. With the handle 42 inserted through the handle opening 19, the paintbrush bristles 43 are positioned over the center panel of the paintbrush cover 11. The pair of side flaps 14 can then be folded over the bristles 43 so as to enclose the bristles 43 within the paintbrush cover. The side flaps 14 are folded in an overlapping configuration so that the side flaps 14 extend over one another.

Subsequently, the upper flap 17 can be folded downward and over the side flaps 14 so that the fastener thereon is faced upward, toward the exterior of the paintbrush cover 11. The lower flap 15 is then folded upward over the side flaps 14 and over the upper flap 17, wherein the fastener 16 on the lower flap 15 is removably secured to the fastener on the upper flap 17. In this way, the upper and lower flap 15, 17 secure the paintbrush cover 11 in position over the bristles 43 of the paintbrush 41, and the side flaps 14 are secured over the bristles 43 and underneath the upper and lower flaps 15, 17.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A paintbrush cover, comprising:
a sheet having a center panel, a pair of side flaps extending from opposing sides of said center panel;
an upper flap extending from an upper portion of the center panel, wherein the upper flap comprises a first fastener thereon;
a lower flap extending from a lower portion of the center panel, wherein the lower flap includes a second fastener thereon that removably engages with the first fastener.

2) The paintbrush cover of claim 1, further comprising a handle opening on said upper flap.

3) The paintbrush cover of claim 1, wherein said center panel is substantially rectangular in shape.

4) The paintbrush cover of claim 1, wherein said sheet is composed of a flexible material.

5) The paintbrush cover of claim 1, wherein said first fastener and said second fastener are hook and loop fastening material.

6) The paintbrush cover of claim 1, wherein said center panel is substantially trapezoidal in shape.

7) The paintbrush cover of claim 1, wherein said pair of side flaps are substantially rectangular in configuration.

8) The paintbrush cover of claim 1, further comprising one or more openings on the lower flap, wherein the openings allow liquid to pass therethrough.
